(19) United States
(12) Patent Application Publication
(10) Pub. No.: US 2005/0258195 A1
(43) Pub. Date: Nov. 24, 2005

(54) Dispenser for solid particulate products

(75) Inventors: Henry L. Carbone, St. Paul, MN (US); Thomas D. Nelson, Maplewood, MN (US); Jim Tarara, Woodbury, MN (US); Scott R. Limback, St. Paul, MN (US); Scott Russell, Woodbury, MN (US)

Correspondence Address: ECOLAB INC., MAIL STOP ESC-F7, 655 LONE OAK DRIVE, EAGAN, MN, 55121, US

(73) Assignee: ESCOLAB INC., St. Paul, MN (US)

(21) Appl. No.: 10/850,001

(22) Filed: May 20, 2004

(51) Int. Cl. G01F 11/10

(52) U.S. Cl. 222/368

(57) ABSTRACT

A method and apparatus for dispensing a solid particulate product, and powders, pellets, granules, and micro-solids in particular, is disclosed. The dispenser includes a housing (12) and a metering device. The dispenser dispenses the solid particulate product while protecting the solid particulate product from environmental conditions such as humidity.

### FIELD OF THE INVENTION

The invention relates generally to dispensers and more particular to a method and apparatus for dispensing a solid particulate product where the solid particulate product is a powder, pellet, granule, or micro-solid.

### BACKGROUND

Solid particulate compositions such as powders, pellets, granules, and micro-solids are a preferred form of many compositions because they are easy to formulate and do not require additional processing whereas liquid and solid compositions typically require additional processing to make them into the desired physical form. Such products may be used for a variety of reasons including as detergents, rinse aids, fabric softeners, bleaches, optical brightening chemicals, starching chemicals, cleaners and sanitizers in general, and as pesticides, for example for flies. However, powders, pellets, granules, and micro-solids are difficult to handle, messy, and susceptible to environmental conditions such as humidity that can cause the composition to clump and disrupt the dispensing. Also, powders, pellets, granules, and micro-solids are difficult to dispense evenly when they contain a mixture of particles having different particle sizes. During dispensing, the particles can segregate resulting in particles of a certain size being dispensed instead of a mixture of particle sizes. Finally, powders, pellets, granules, and micro-solids are difficult to dispense using gravity feed dispensers because oftentimes the dispenser is not designed for optimal flow properties, allowing the product to build up on the edge of the dispenser, causing bridging or arching and sometimes forming ratholes. These phenomena will cause the dispenser to jam, cause irregular flow patterns, and prevent all of the product in the dispenser from being dispensed. Therefore, a need exists for a dispenser that can dispense powders, pellets, granules, and micro-solids while protecting the composition from environmental conditions and making the composition easy to dispense.

### SUMMARY

The present invention relates to a dispenser for solid particulate products, including powders, pellets, granules, and micro-solids.

In one embodiment, the invention relates to a dispenser for dispensing solid particulate products, the dispenser having a housing for product coupled to a metering device. The housing includes an outlet.

In another embodiment, the invention relates to a dispensing system for dispensing solid particulate products. The dispensing system includes a dispenser having a housing for product coupled to a metering device. The housing includes an outlet.

In another embodiment, the invention relates to a method of dispensing a solid particulate product. The method includes dispensing a solid particulate product from a dispenser, the dispenser having a housing for product coupled to a metering device. The housing includes an outlet.

In another embodiment, the invention relates to a dispenser for insect or rodent particulate bait for use around a dumpster or garbage area. The dispenser includes a housing and a metering device. The metering device may be a rotary drum. The dispenser optionally includes a drop tube and a scattering device. The dispenser also optionally includes a control device and a power supply.

### BRIEF DESCRIPTION OF THE DRAWINGS

FIG. 1 shows the hidden lines of an assembled view of an embodiment of the dispenser of the present invention with a rotary valve;

FIG. 2 is an exploded view of a rotary valve metering device, an embodiment of the present invention;

FIG. 3 is an exploded view of a rotary valve metering device, an embodiment of the present invention showing the hidden lines;

FIG. 4 is an exploded view showing the hidden lines of an embodiment of the dispenser of the present invention with a rotary valve;

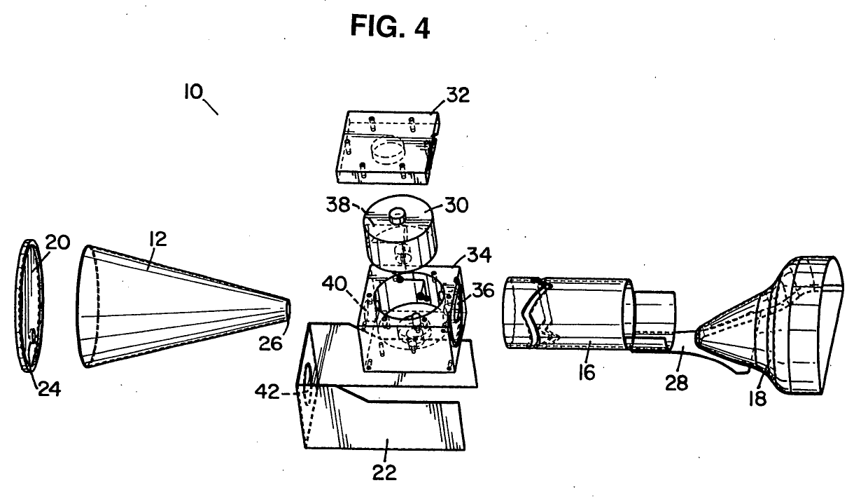

FIG. 5 is an assembled view showing the hidden lines of the actuated plunger metering device, an embodiment of the present invention;

FIG. 6 shows the hidden lines of a horizontal dosing metering device in the filling position, an embodiment of the present invention;

FIG. 7 shows the hidden lines of a horizontal dosing metering device in the dispensing position, an embodiment of the present invention;

FIG. 8 shows the hidden lines of a vertical dosing metering device in the filling position, an embodiment of the present invention;

FIG. 9 shows the hidden lines of a vertical dosing metering device in the dispensing position, an embodiment of the present invention;

FIG. 10 shows the assembled view of the sleeve/plunger metering device in the filling position, an embodiment of the present invention;

FIG. 11 shows the assembled view of the sleeve/plunger metering device in the closed position, an embodiment of the present invention;

FIG. 12 shows the assembled view of the sleeve/plunger metering device in the dispensing position, an embodiment of the present invention;

FIG. 13 shows the hidden lines of a rotary valve metering device having four dispensing chambers, an embodiment of the present invention.

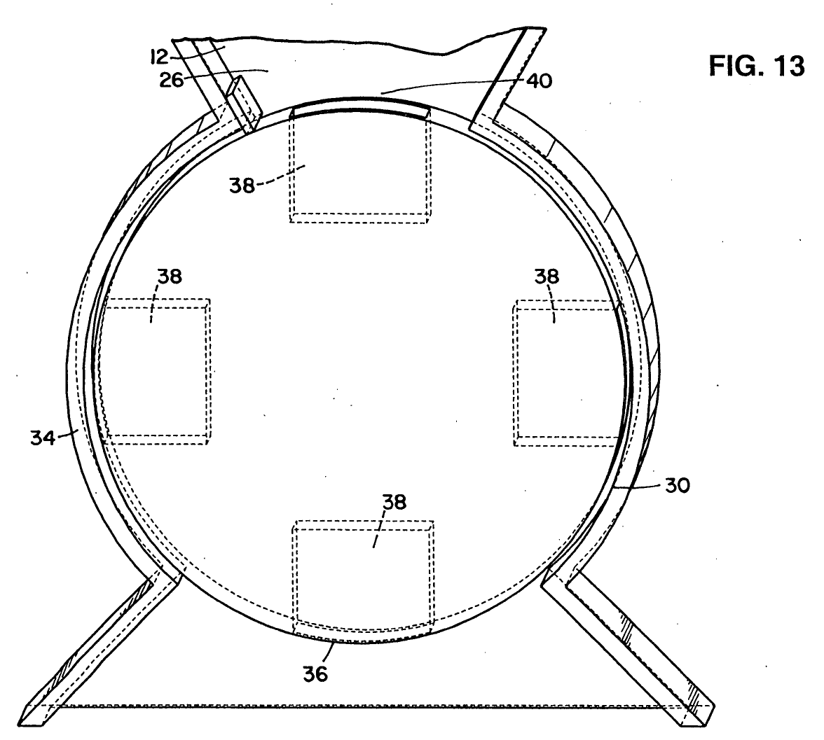

### DETAILED DESCRIPTION

Definitions

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the term “about” may include numbers that are rounded to the nearest significant figure.

The recitation of numerical ranges by endpoints includes all numbers subsumed within that range (e.g. 1 to 5 includes 1, 1.5, 2, 2.75, 3, 3.80, 4 and 5).

As used in this specification and the appended claims, the singular forms “a,” “an,” and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

The Dispenser

Referring to the drawings, wherein like numerals represent like parts throughout the several views, there is generally disclosed at 10 a dispenser for a solid particulate product. Solid particulate is understood to mean a product relating to or existing as minute separate particles. The dispenser 10 may be mounted to a wall or other structure, may be hung from a structure, or may be free standing. The dispenser 10 includes a housing 12. The housing 12 may be made out of plastic, metal, wood, fiberglass, carbon fiber composites, or mixtures thereof. The housing 12 is preferably made out of plastic or metal. The housing 12 optionally has an inlet 24 where the solid particulate product may enter the housing 12. The housing 12 has an outlet 26 where the solid particulate product exits the housing 12. The inlet may be in a lid 20. Lid 20 may be permanently fixed to the housing 12 or lid 20 may be removable. The housing 12 may be a cylinder, a funnel, a mass flow funnel, the product's packaging itself, or any container having an outlet 26. Where the housing 12 is the product packaging, the housing 12 would not necessarily include an inlet. The term mass flow funnel is understood to mean a funnel designed according to mass flow properties of particulates. A mass flow funnel typically has steep walls such that the particulates flow along the sides of the funnel at substantially similar rates as product flows through the center of the funnel. Mass flow funnels are known to prevent ratholes from forming, reduce bridging and arching, limit segregation, and provide a uniform flow rate. A rathole is the phenomenon associated with particulate flow in a cylindrical or conical chamber where product dispenses from the center of the chamber and not from the sides leaving a hole in the center of the product. Arching or bridging refers to the phenomena associated with particulate flow in a cylindrical or conical chamber where the product forms a bridge or arch at the exit of the chamber thereby preventing additional product from flowing out of the exit. The housing 12 is preferably a mass flow funnel because of these benefits. When dispensing particulate products, limiting segregation allows a more uniform blend of particulate sizes to be dispensed. Additionally, the prevention of ratholes, bridges and arches prevents the dispenser from jamming. Finally, a uniform flow rate is of importance, especially when the metering device selected is based on time, for example, the length of time a plug is open allowing a certain amount of product to flow. While the mass flow funnel is the preferred funnel, it is understood that any container having an outlet 26 may be selected for the housing 12.

The housing preferably assists in keeping out environmental conditions such as humidity. Humidity will cause the particulate product to clump or stick together, making it difficult to uniformly dispense the product and causing the metering device to clog and render the apparatus ineffective. The housing may assist to keep out humidity in a number of ways. In certain embodiments, the housing may be air tight to prevent humidity from entering the housing when it is closed. In certain embodiments, the housing may include a desiccant to absorb any humidity present in the housing. In certain embodiments, the housing may include an additional chamber inside the housing. This chamber may be air tight. The chamber may include a desiccant. In certain embodiments, the housing may only be opened when necessary to service the dispenser and provide additional product to the housing. For example, in certain embodiments, the housing may only be opened once every 30 days in order to service the dispenser and provide additional product to the housing. In between the servicing, the housing would preferably remain closed to prevent additional humidity from entering into the housing. In certain embodiments, the housing is filled with product during low humidity, for example at night, and/or when it is not precipitating in order to assist in keeping humidity out of the housing. The housing is designed such that when the bait is loaded when humidity is less that 80% RH, the housing will not allow the relative humidity inside of the housing to increase above 80% RH. In other words, the housing is designed to keep the humidity inside the housing to the relative humidity at the time when the bait is loaded if the outside relative humidity increases after the housing is closed. In certain embodiments, it may be preferable to fill up the housing completely when adding additional product to the housing. It is believed that filling up the housing completely with product allows the product to displace any humidity that is present in the housing and therefore bring the relative humidity (RH) level down. In certain embodiments, it is preferred that the housing be capable of keeping the relative humidity level below a certain percentage as measured by a Hotpack Environmental Chamber (Model Number 417532), commercially available from Hotpack Corp. (Philadelphia, Pa.). For example, in an embodiment, the housing is capable of keeping the humidity level of the air inside the housing to less than 80% RH when the air temperature outside the housing is 33° C./90° F. In an embodiment, the housing is capable of keeping the humidity level of the air inside the housing to less than 70% RH when the air temperature outside the housing is 33° C./90° F. In an embodiment, the housing is capable of keeping the humidity level of the air inside the housing to less than 60% RH when the air temperature outside the housing is 33° C./90° F.

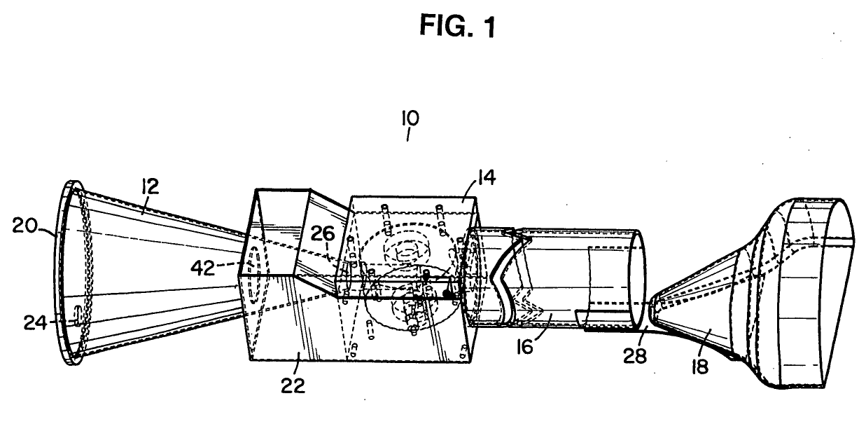

The housing 12 is coupled to a metering device. In FIG. 1, the metering device is a rotary valve, general disclosed at 14. The metering device may be any metering device including but not limited to a rotary valve, an actuated plunger, a dosing device having a void space of fixed volume, a sleeve/plunger combination, and others. The purpose of the metering device is to measure out a quantity or dosage of solid particulate product to be dispensed. The metering device may be volumetric or time based. The dosage may be fixed or may be adjustable.

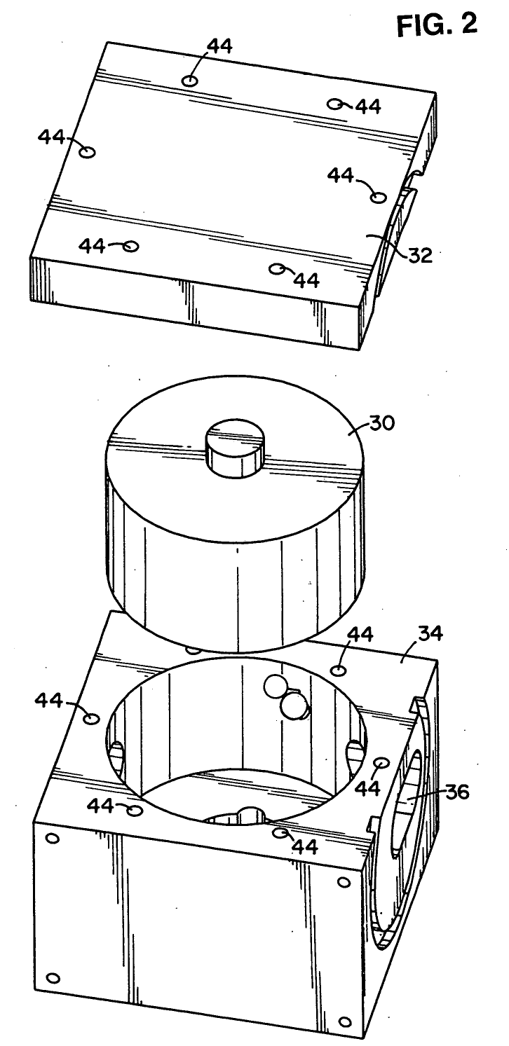

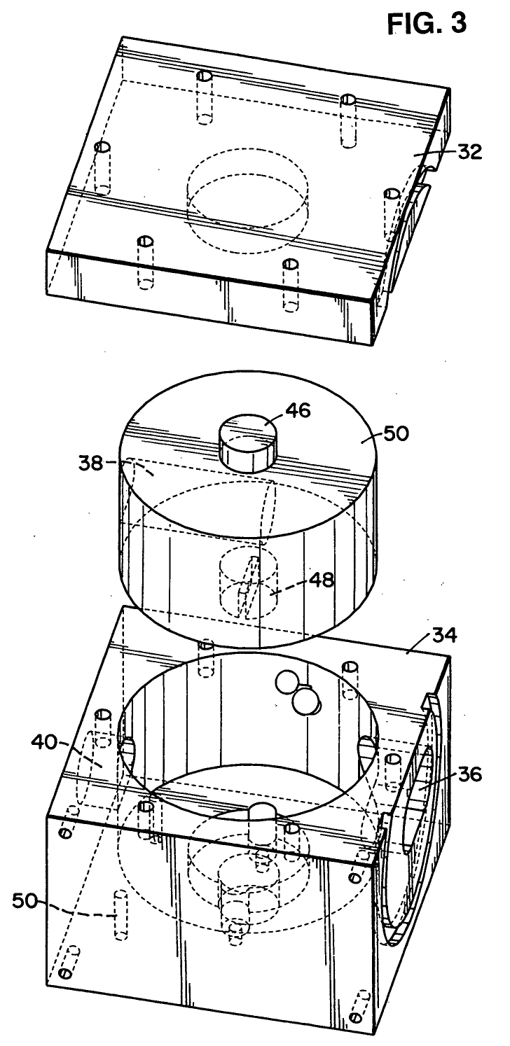

The rotary valve metering device embodiment 14 is shown in FIGS. 1-3. The rotary valve 14 has a rotary drum 30. Rotary drum 30 rotates inside the rotary drum housing 34. The rotary drum housing has two apertures, 36 and 40. Aperture 40 receives the solid particulate product from the housing 12 when the rotary drum 30 is in the filling position. The solid particulate product exits out aperture 36 when the rotary drum 30 is in the dispensing position. The rotary drum housing 34 also has mounting holes for the motor 50 that connect the rotary drum housing 34 to the motor (not shown). The rotary drum housing cover 32 is placed over the rotary drum 30 on the rotary drum housing 34. The rotary drum housing cover 32 and the rotary drum housing 34 have apertures for fasteners 44. The fasteners (not shown) may be screws, nails, or other fastening device, and hold the rotary drum housing cover 32 in rigid communication with the rotary drum housing 34. Rotary drum 30 has two axles, 46 and 48, that allow the rotary drum to rotate inside the rotary drum housing 34. Axle 48 is a slotted axle that couples to a motor or other device for rotating rotary drum 30. Rotary drum 30 also has a chamber 38. The rotary drum 30 may optionally include a plurality of chambers as shown in FIG. 21. A fixed volume of solid particulate product exits housing 12 through the outlet 26, passes through aperture 40, and enters chamber 38 when rotary drum 30 is in the filling position. Rotary drum 30 then rotates to the dispensing position and empties the fixed volume of solid particulate product out aperture 36. Rotary drum 30 then rotates back to the filling position and the cycle may be repeated. Tight tolerances between the rotary drum 30, the rotary drum housing 34, and the rotary drum housing cover 32 protect the solid particulate product in the housing 12 and chamber 38 from environmental conditions such as humidity.

In an embodiment, the rotary drum may be removable in order to facilitate servicing or replacement. In this embodiment, removable fasteners can be used to secure the rotary housing cover 32 to the rotary drum housing 34. In an embodiment, axel 46 can incorporate a removal device to facilitate removal of the rotary drum 30. In one embodiment the removal device can be a coupling such as a threaded port to which an extraction device can be coupled to. In one embodiment, the removal device can be a tab that can be grasped by a hand or tool to release the rotary system.

When the rotary drum 30 is the metering device, the housing 12 is connected to rotary drum 30 by a frame 22. Frame 22 has an aperture 42. The housing 12 is placed in the aperture 42 such that outlet 26 is in communication with aperture 40 and chamber 38 when rotary drum 30 is in the filling position.

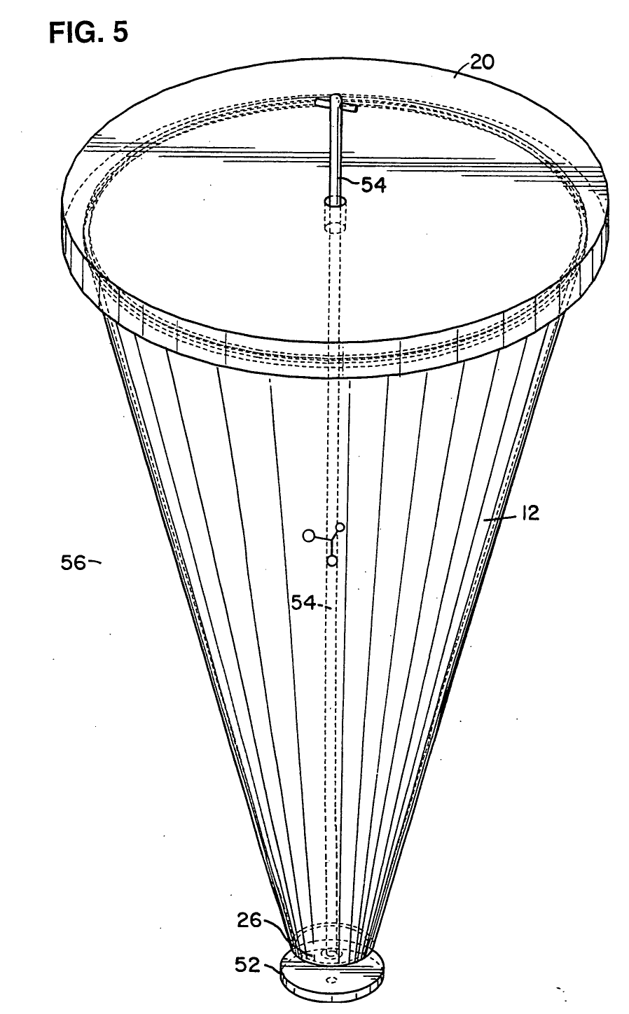

Another embodiment is the actuated plunger metering device 56 shown in FIG. 5. For the actuated plunger metering device the housing 12 contains a plunger shaft 54. At the end of the plunger shaft 54 is a plunger plug 52. Plunger plug 52 seals the housing 12 at aperture 26 from environmental conditions. The plunger plug 52 may be made of a variety of materials including but not limited to plastic, metal, and rubber. The plunger shaft 54 is actuated by an actuating device (not shown). The actuating device may be a motor driven cam, a solenoid, or other actuation means. Upon actuation the plunger shaft 54 is moved along its axis such that when activated the plunger plug 52 moves away from aperture 26 allowing the solid particulate product to be dispensed. With this design, the open time of the dispenser is adjusted to modify the quantity of the product dispensed.

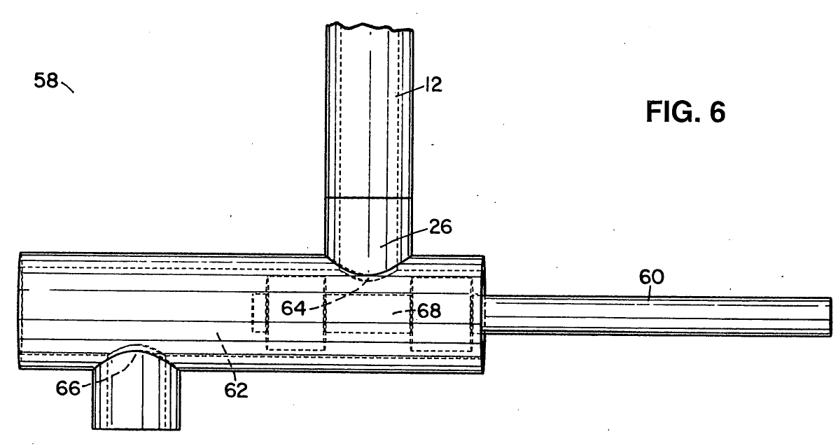

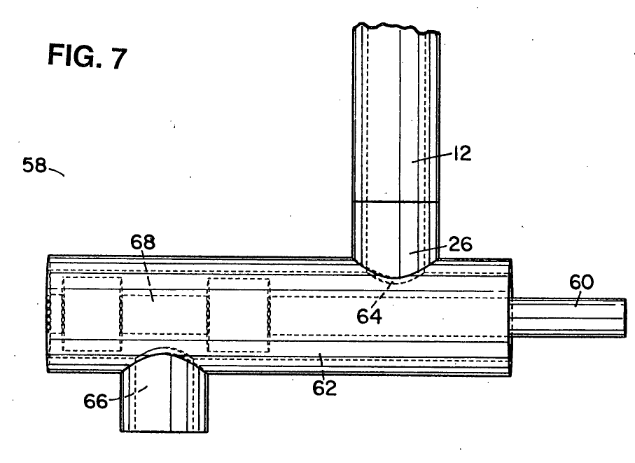

Yet another embodiment is the horizontal dosing metering device 58 shown in FIGS. 6 and 7. For the horizontal dosing metering device 58, the housing 12 is coupled to a shaft 62. Shaft 62 has two apertures, 64 and 66. Aperture 64 is connected to aperture 26 in housing 12. Shaft 62 has piston 60 that moves along a horizontal axis from a filling position to a dispensing position. FIG. 6 shows the filling position. FIG. 7 shows the dispensing position. Piston 60 has a chamber 68. In the filling position, chamber 68 is aligned with aperture 64 of shaft 62. During the filling position, a fixed volume of solid particulate product is dispensed from the housing 12, through apertures 26 and 64, and enters chamber 68. Piston 60 then moves along a horizontal axis from the filling position to the dispensing position. In the dispensing position, the fixed volume of solid particulate product is dispensed from chamber 68 through aperture 66.

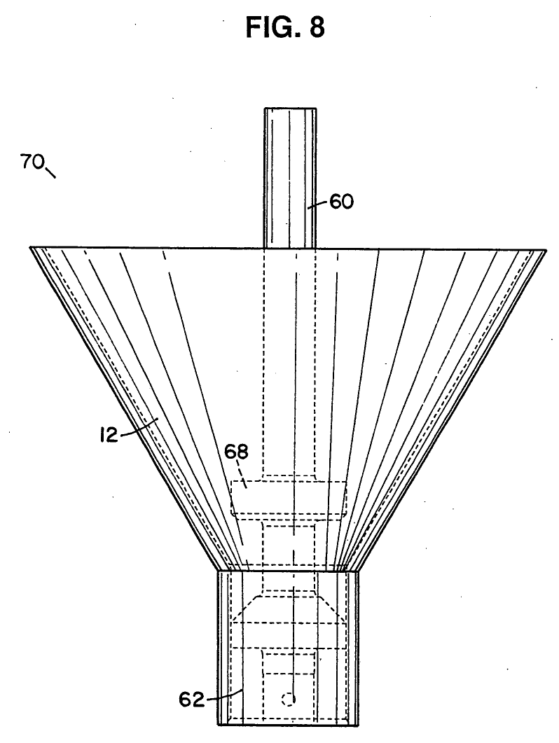

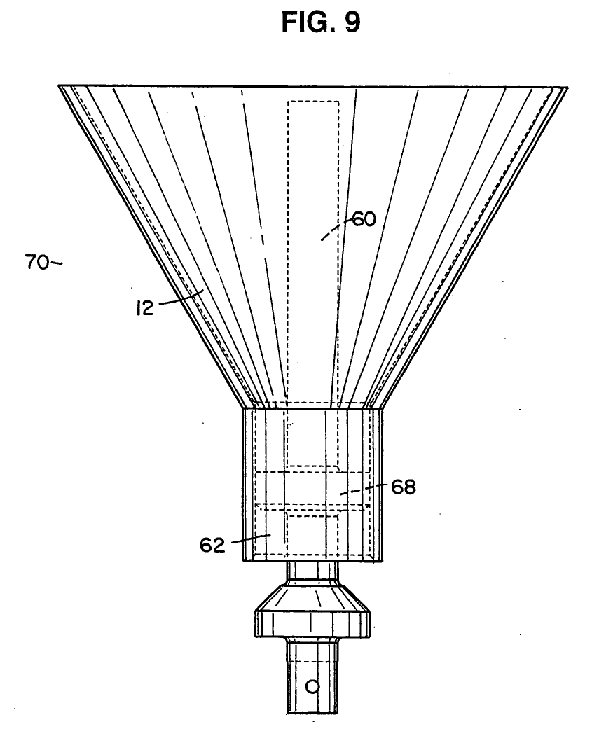

Still another embodiment is the vertical dosing metering device 70 shown in FIGS. 8 and 9. For the vertical dosing metering device 70, the housing 12 is coupled to a shaft 62. Shaft 62 has piston 60 that moves along a vertical axis from a filling position to a dispensing position. FIG. 8 shows the filling position. FIG. 9 shows the dispensing position. Piston 60 has a chamber 68. In the filling position, chamber 68 is inside housing 12. During the filling position, a fixed volume of solid particulate product is dispensed into chamber 68. Piston 60 then moves along a vertical axis from the filling position to the dispensing position. In the dispensing position, the fixed volume of solid particulate product is dispensed from chamber 68.

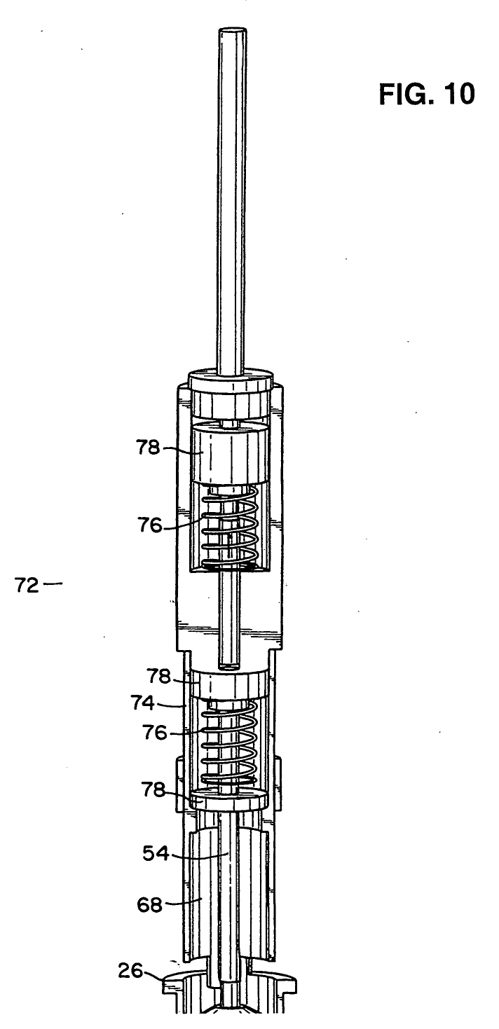

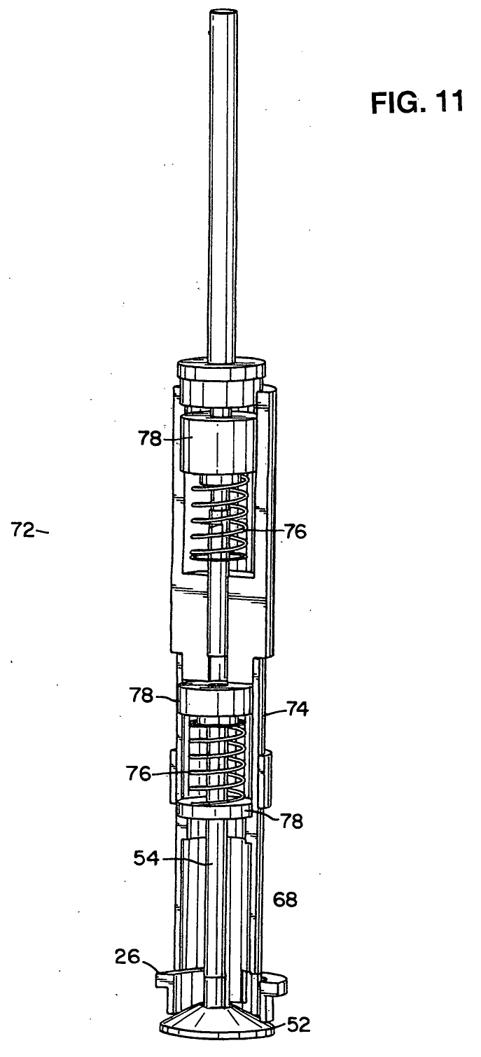

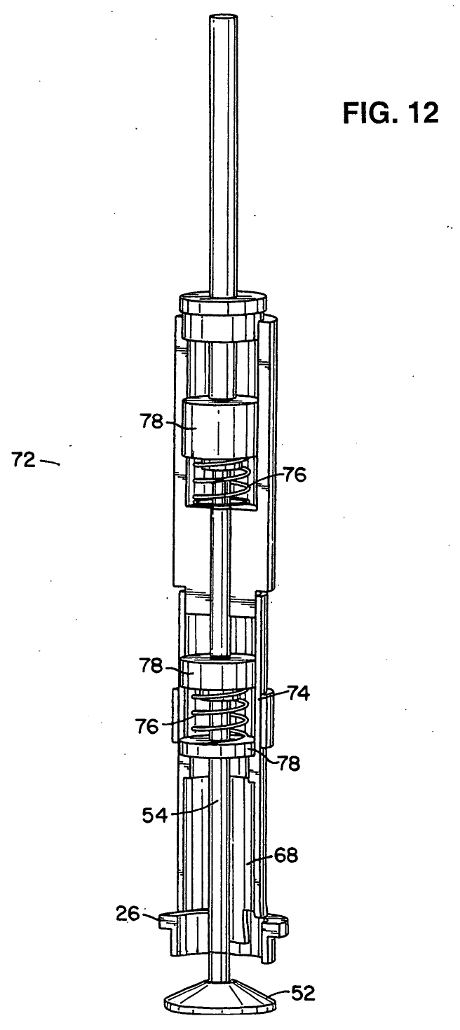

Still a further embodiment is the sleeve/plunger metering device 72 shown in FIGS. 10-12. For the sleeve/plunger metering device 72, a sleeve 74 is located inside housing 12. Inside sleeve 74 is a plunger shaft 54. Plunger shaft 54 has springs 76 located between discs 78. At the end of plunger shaft 54 is a plunger plug 52 and a chamber 68. Plunger plug 52 seals the end of housing 12 at aperture 26 from environmental conditions. The sleeve/plunger metering device 72 has three positions: a filling position (FIG. 10), a closed position (FIG. 11), and a dispensing position (FIG. 12). During the filling position, sleeve 74 is spaced apart from housing 12, allowing a fixed amount of solid particulate product to fill chamber 68. During the closed position, plunger shaft 54 is moved along its axis to come into contact with the housing 12. In the closed position, solid particulate product cannot enter chamber 68, but plunger plug 52 is still sealed against aperture 26. In the dispensing position, the plunger shaft 54 is moved further along its axis such that the plunger plug 52 is moved away from aperture 26 and the solid particulate product is dispensed out aperture 26 from chamber 68. Plunger shaft 54 is actuated by an actuating device (not shown). The actuating device may be a motor driven cam, a solenoid, or other actuation means.

The dispenser 10 of the present invention may optionally include a drop tube 16. Drop tube 16 may be coupled to either the housing 12 at aperture 26 or the metering device where the solid particulate product is dispensed. The purpose of drop tube 16 is to carry the solid particulate product a distance without the solid particulate product being blown away. The drop tube 16 may be any length necessary. The drop tube 16 may be made of plastic, metal, wood, fiberglass, carbon fiber composites or any material.

The solid particulate product may be dispensed directly from the housing 12, the metering device, or the drop tube 16. Alternatively, the dispenser 10 of the present invention may optionally include a scattering device for dispersing the product over a desired area. The scattering device may scatter the solid particulate product in a variety of ways. For example, in one embodiment, the scattering device may have a deflection plate 18 such that upon hitting the defection plate, the solid particulate product is scattered. When used in conjunction with deflection plate 18, drop tube 16 protects the product from wind, air currents, etc. and directs the product towards the deflection plate 18 as the product falls some vertical distance. While falling, the product increases in velocity under the force of gravity. This vertical motion vector of the falling product is partially translated into a horizontal motion vector when the product strikes the deflection plate 18, thereby causing the product to be scattered. The defection plate 18 may have a variety of shapes including conical, flat, curved, or “cyclonic funnel.” In another embodiment, the scattering device may also be a rotating disk such that when the solid particulate product is dispensed, it is dispensed onto the rotating disk and scattered. In yet another embodiment, the scattering device may also be a flat plate having an arm such that when the solid particulate product is dispensed onto the scattering device, the arm swings to scatter the solid particulate product over the desired area. Preferably, in this embodiment, one end of the arm rotates about a point and the other end of the arm is preferably held in position as rotation of the arm begins such that potential energy is stored in the arm in the form of elastic deflection of the arm. Once the held end of the arm is released, the potential energy is converted to kinetic energy allowing the arm to “spring” forward and scatter the solid particulate product. In still another embodiment, the scattering device 18 may be a shaker plate. The scattering device 18 may be connected to the drop tube 16, the housing 12 or the metering device by a connector 28. The connector 28 holds the scattering device 18 in rigid communication with the rest of the dispenser 10.

The dispenser 10 of the present invention may optionally be contained in a secondary cabinet (not shown). The secondary cabinet may optionally include a locking device to lock the dispenser 10 inside the secondary cabinet. The purpose of the secondary cabinet is to prevent unauthorized access to the solid particulate product, for example by children. Also, the secondary cabinet may be used to mount or hang the dispenser 10 either on a wall or other structure. The secondary cabinet may also be free standing.

The metering device may optionally be coupled to a power supply (not shown). Some non-limiting examples of power supplies include a battery, a rechargeable battery, manual power, solar power, stored mechanical energy, spring, a standard electrical outlet, and potential energy.

The metering device may optionally be coupled to a control device (not shown) that controls the dispensing of the solid particulate product. Some non-limiting examples of control devices include a timer, a limit switch, a photo sensor, an impact weigher, a load cell, a microprocessor, a manual control, a push button, a laundry machine wash cycle, a warewashing machine wash cycle.

The dispenser 10 may be used to dispense solid particulate products such as detergents in laundry and warewashing machines, and pesticides. The pesticide may include incesticides, rodenticides, and the like. Some non-limiting examples of suitable pesticides include the following: ECO2000-GR insecticidal bait granules (0.4 mm to 2 mm), commercially available from Ecolab Inc.; Stimukil insecticidal bait granules (˜3 mm), commercially available from Troy Bioscience; Max Force fly bait (5 mm×1 mm), commercially available from Bayer; Ecolab Rat & Mouse Exterminator rodenticidal pellet bait (10 mm×5 mm), commercially available from Ecolab Inc.; and Maki Rat & Mouse Bait, rodenticidal bait pellet (10 mm×5 mm), commercially available from LiphaTech). The pesticide may be provided in areas where scattering of the pesticide or bait is desired such as around a garbage dumpster.

For a more complete understanding of the invention, the following examples are given to illustrate some embodiment. These examples and experiments are to be understood as illustrative and not limiting.

### EXAMPLES

### Example 1

Example 1 shows the ability of various dispensers to dispense a given dosage of fly bait consistently. Four metering devices were tested, the rotary drum, the horizontal dosing, the actuated plunger, and the sleeve/plunger. The test was conducted at ambient temperature. Dispenses were triggered in succession using a manual switch. The difference in weight in a cup was recorded.

TABLE 1
Ounces Dispensed Using Different Metering Devices

| | Rotary | Horizontal | Actuated | Sleeve/ |
|---|---|---|---|---|
| Dispense | Drum | Dosing | Plunger | Plunger |
| 1 | 0.525523 | 0.405605 | 0.36 | 0.052905 |
| 2 | 0.514237 | 0.405605 | 0.28 | 0.088175 |
| 3 | 0.508241 | 0.42324 | 0.18 | 0.123445 |
| 4 | 0.513531 | 0.42324 | 0.3 | 0.084648 |
| 5 | 0.511415 | 0.42324 | 0.3 | 0.14108 |
| 6 | 0.509652 | 0.42324 | 0.28 | 0.063486 |
| 7 | 0.505419 | 0.38797 | 0.34 | 0.081121 |
| 8 | 0.504008 | 0.42324 | 0.4 | 0.07054 |
| 9 | 0.500834 | 0.42324 | 0.14 | 0.049378 |
| 10 | 0.510004 | 0.405605 | 0.42 | 0.091702 |
| 11 | 0.502597 | 0.440875 | 0.38 | 0.102283 |
| 12 | 0.504714 | 0.405605 | 0.44 | 0.077594 |
| 13 | 0.506124 | 0.440875 | 0.3 | 0.052905 |
| 14 | 0.51071 | 0.42324 | 0.42 | 0.017635 |
| 15 | 0.513179 | 0.42324 | 0.32 | 0.067013 |
| 16 | 0.506477 | 0.405605 | 0.38 | 0.14108 |
| 17 | 0.509299 | 0.440875 | 0.4 | 0.134026 |
| 18 | 0.501892 | 0.42324 | 0.44 | 0.102283 |
| 19 | 0.501187 | 0.42324 | 0.36 | 0.123445 |
| Average | 0.508371 | 0.419527 | 0.338947 | 0.087618 |
| Standard | 0.005924 | 0.013885 | 0.08232 | 0.034241 |
| Deviation | | | | |

In Table 1, the rotary drum metering device was the most consistent over twenty dispenses because it had the lowest standard deviation. The next most consistent was the horizontal dosing metering device, followed by the sleeve/plunger, and then the actuated plunger.

### Example 2

Example 2 shows the impact of humidity on two known insecticides, Stimukil a granular fly bait, commercially available from Troy Bioscience, and MaxForce, a granular fly bait, commercially available from Bayer. For this example, a Hotpack Environmental Chamber (Model Number 417532), commercially available from Hotpack Corp. (Philadelphia, Pa.) was preset to a desired temperature and relative humidity (RH). Ten grams of the insecticide was placed in the Hotpack Environmental Chamber. After one day, a probe was used to touch the insecticide to determine if the insecticide was stuck together. Also, the color of the insecticide was noted.

TABLE 2
Impact of Humidity on Insecticide

| | Day 1 | Day 2 | Day 3 | Day 4 |
|---|---|---|---|---|
| Humidity | 60% RH | 70% RH | 80% RH | 90% RH |
| Temperature | 33° C./90° F. | 33° C./90° F. | 33° C./ | 33° C./ |
| | | | 90° F. | 90° F. |

Insecticide

| | | | | |
|---|---|---|---|---|
| Stimukil | No color | No color | No color | Dark blue. |
| | change. | change. | change. | Partially |
| | | | | dissolved. |
| | Does not stick | Does not stick | Does not | Stuck |
| | together. | together. | stick | together. |
| | | | together. | |
| MaxForce | No color | No color | No color | Dark red. |
| | change. | change. | change. | Partially |
| | | | | dissolved. |
| | Does not Stick | Does not Stick | Starting to | Stuck |
| | together. | together | stick | together. |
| | | | together. | |

TABLE 3
Impact of Humidity on Insecticide

| | Day 1 | Day 2 | Day 3 | Day 4 |
|---|---|---|---|---|
| Humidity | 60% RH | 60% RH | 60% RH | 60% RH |
| Temperature | 33° C./90° F. | 33° C./90° F. | 33° C./ | 33° C./ |
| | | | 90° F. | 90° F. |

Insecticide

| | | | | |
|---|---|---|---|---|
| Stimukil | No color | No color | No color | No color |
| | change. | change. | change. | change. |
| | Does not stick | Does not stick | Does not | Does not |
| | together. | together. | stick | stick |
| | | | together. | together. |
| MaxForce | No color | No color | No color | No color |
| | change. | change. | change. | change. |
| | Does not Stick | Does not Stick | Does not | Does not |
| | together. | together | Stick | stick |
| | | | together. | together. |

Table 2 shows that the Stimukil insecticide did not start sticking together until the relative humidity was above 80%. The MaxForce insecticide did not start sticking together until the relative humidity was above 70% and was not stuck together until the relative humidity was above 80%. Table 3 shows the impact of time on the consistency of the insecticides. In Table 3, the relative humidity was kept constant over four days instead of increased as in Table 2. Neither the Stimukil nor the MaxForce stuck together after four days when the relative humidity was kept at a constant 60%. Table 2 and Table 3 show that it was the increased relative humidity, and not time, that cause the two insecticides to be stuck together after four days.

The foregoing summary, detailed description, and examples provide a sound basis for understanding the invention, and some specific example embodiments of the invention. Since the invention can comprise a variety of embodiments, the above information is not intended to be limiting. The invention resides in the claims.

1. A solid particulate product dispenser comprising:
a. a housing; and
b. a metering device coupled to the housing,
wherein the humidity of the air inside the housing is less than 80% RH.

2. The dispenser of claim 1, further comprising a drop tube coupled to the metering device.

3. The dispenser of claim 2, further comprising a scattering device coupled to the drop tube.

4. The dispenser of claim 1, further comprising a control device coupled to the metering device.

5. The dispenser of claim 4, further comprising a power supply coupled to the control device.

6. The dispenser of claim 1, wherein the housing is made out of a material comprising at least one of plastic, metal, wood, fiberglass, carbon fiber composite, and combinations thereof.

7. The dispenser of claim 1, wherein the housing has an outlet connecting the housing and the metering device.

8. The dispenser of claim 1, wherein the housing has an inlet for introducing particulate product into the housing.

9. The dispenser of claim 8, wherein the inlet is a lid.

10. The dispenser of claim 9, wherein the lid is removable from the housing.

11. The dispenser of claim 9, wherein the lid is permanently fixed to the housing.

12. The dispenser of claim 1, wherein the housing is at least one of a cylinder, a funnel, a mass flow funnel, the particulate product packaging, and combinations thereof.

13. The dispenser of claim 1, wherein the metering device is a volumetric metering device.

14. The dispenser of claim 1, wherein the metering device is a time based metering device.

15. The dispenser of claim 1, wherein the metering device is at least one of a rotary valve, an actuated plunger metering device, a horizontal dosing device, a vertical dosing device, and a sleeve/plunger metering device.

16. The dispenser of claim 2, wherein the drop tube is a material comprising at least one of plastic, metal, wood, fiberglass, carbon fiber composite, and combinations thereof.

17. The dispenser of claim 3, wherein the scattering device comprises at least one of a deflection plate, a rotating disk, a shaker plate, and a flat plate.

18. The dispenser of claim 4, wherein the control device comprises at least one of a timer, a limit switch, a photo sensor, an impact weigher, a load cell, a microprocessor, a manual control, a push button, a laundry machine wash cycle, a warewashing machine wash cycle, and combinations thereof.

19. The dispenser of claim 5, wherein the power supply comprises at least one of a battery, a rechargeable battery, manual power, solar power, stored mechanical energy, a spring, a standard electrical outlet, potential energy, and combinations thereof.

20. The dispenser of claim 1, wherein the particulate product comprises at least one of a laundry detergent, a warewashing detergent, and a pesticide.

21. The dispenser of claim 1, wherein the particulate product comprises at least one of a powder, pellet, granule, micro-solid, and combinations thereof.

22. A solid particulate product dispenser comprising:
a. a housing;
b. a metering device coupled to the housing;
c. a drop tube coupled to the metering device; and
d. a scattering device coupled to the drop tube.

23. A solid pesticide particulate dispenser comprising:
a. a housing wherein the housing is a mass flow funnel;
b. a rotary drum metering device coupled to the housing;
c. a drop tube coupled to the metering device; and
d. a scattering device coupled to the metering device.

24. A method of dispensing a solid particulate product comprising:
a. providing a solid particulate product in a housing, wherein the housing is coupled to a metering device;
b. activating the metering device to dispense the solid particulate product from the housing; and
c. dispensing the solid particulate product.

25. The method of claim 24, wherein the humidity of the air inside the housing is less than 80% RH.

26. The method of claim 24, wherein the housing is made out of a material comprising at least one of plastic, metal, wood, fiberglass, carbon fiber composite, and combinations thereof.

27. The method of claim 24, wherein the housing has an outlet connecting the housing and the metering device.

28. The method of claim 24, wherein the housing has an inlet for introducing particulate product into the housing.

29. The method of claim 28, wherein the inlet is a lid.

30. The method of claim 29, wherein the lid is removable from the housing.

31. The method of claim 29, wherein the lid is permanently fixed to the housing.

32. The method of claim 24, wherein the housing is at least one of a cylinder, a funnel, a mass flow funnel, the particulate product packaging, and combinations thereof.

33. The method of claim 24, wherein the metering device is a volumetric metering device.

34. The method of claim 24, wherein the metering device is a time based metering device.

35. The method of claim 24, wherein the metering device is at least one of a rotary valve, an actuated plunger metering device, a horizontal dosing device, a vertical dosing device, and a sleeve/plunger metering device.

36. The method of claim 24, wherein the particulate product comprises at least one of a laundry detergent, a warewashing detergent, and a pesticide.

37. The method of claim 24, wherein the particulate product comprises at least one of a powder, pellet, granule, micro-solid, and combinations thereof.

38. A method of dispensing a solid pesticide particulate product comprising:
a. providing a solid pesticide particulate product in a housing, wherein the housing is a mass flow funnel and the housing is coupled to a rotary drum metering device;
b. activating the rotary drum metering device to dispense the solid pesticide particulate product from the housing; and
c. dispensing the solid pesticide particulate product.
